(19) United States
(12) Patent Application Publication
(10) Pub. No.: US 2024/0423409 A1
(43) Pub. Date: Dec. 26, 2024

(54) System For Reversibly Attaching An Accessory To A Hot Water/Steam Dispensing Outlet, Corresponding Accessory And Beverage Dispensing Machine

(71) Applicant: SEB S.A., Ecully (FR)

(72) Inventors: Léo Cornu, Ecully Cedex (FR); Jean-Baptiste Giraud, Ecully Cedex (FR); Annabelle Guillot, Ecully Cedex (FR)

(73) Assignee: SEB S.A., Ecully (FR)

(21) Appl. No.: 18/748,893

(22) Filed: Jun. 20, 2024

(30) Foreign Application Priority Data
Jun. 20, 2023 (FR) 2306385

(51) Int. Cl. A47J 31/44

(52) U.S. Cl. CPC A47J 31/4489; A47J 31/4485

(57) ABSTRACT

A system for reversibly attaching an accessory to a hot water and/or steam dispensing outlet of a beverage dispensing machine includes a main body and a locking element. The locking element is received in the main body and includes two elastically deformable arms designed to cooperate with at least one locking relief formed on the dispensing outlet. The arms are configured to be moved between a position in which the accessory is locked to the dispensing outlet and an unlocked position.

### TECHNICAL FIELD

The present invention relates to the field of attachments to hot water and/or steam dispensing outlets of beverage dispensing machines, in particular coffee machines. Such accessories are, for example, a hot water dispensing accessory or milk frothing devices such as milk jugs, or a steam nozzle or frothing nozzle defining milk, steam and advantageously air inlet channels and a frothed milk outlet channel.

### STATE OF THE ART

CN109528007 discloses a coffee machine equipped with a milk frothing device comprising a system for attachment to a steam dispensing outlet. The attachment system comprises a flexible latch positioned on the coffee machine near the steam dispensing outlet and a locking relief formed on a body of the frothing device and designed to cooperate with the latch.

Such an attachment system enables the milk frothing device to be reversibly attached to the steam dispensing outlet.

However, such an attachment system is not optimized and does not guarantee optimal user safety. Indeed, the frothing device might be ejected or steam projected towards the user in the event of overpressure, due in particular to clogging of the frothing device. In addition, operating the attachment system is complex for the user.

### SUMMARY OF THE INVENTION

This invention is intended to remedy these disadvantages.

The technical problem underlying the invention is to provide a system for reversibly attaching an accessory to a hot water and/or steam dispensing outlet of a beverage dispensing machine, thereby ensuring the user's safety and making operation easier.

To this end, the invention relates to a system for reversibly attaching an accessory to a hot water and/or steam dispensing outlet of a beverage dispensing machine, the attachment system comprising a main body and a locking element. In accordance with the invention, the locking element is received in the main body and comprises two elastically deformable arms designed to cooperate with at least one locking relief formed on the dispensing outlet, the arms being designed to be moved between a position in which the accessory is locked to the dispensing outlet and an unlocked position.

The invention optimizes the attachment of the accessory to the hot water and/or steam dispensing outlet, since the locking element is received/protected by the main body and comprises two elastically deformable arms enabling the accessory to be reliably and securely locked to the dispensing outlet. In addition, operating the attachment system is simple for the user.

According to advantageous but non-mandatory aspects of the invention, such an attachment system can incorporate one or more of the following features, taken in any technically permissible combination.

According to an advantageous feature of the invention, the locking element comprises a bearing surface, and the arms are designed to be moved into the unlocked position when the user presses on the bearing surface, and to return to the locked position when the user stops pressing.

Such an arrangement makes it easier to operate the locking element, and in particular for the user to move the arms to the unlocked position. Indeed, simply pressing on the bearing surface is sufficient.

According to an advantageous feature of the invention, the main body comprises an access port to the bearing surface.

Such an arrangement makes it easier for the user to access the bearing surface and therefore to operate the attachment system.

According to an advantageous feature of the invention, the locking element comprises a through port for the dispensing outlet extending between the two arms, through which the dispensing outlet is arranged when the accessory is attached to the dispensing outlet.

Such an arrangement ensures optimized attachment of the accessory to the dispensing outlet using the attachment system.

According to an advantageous feature of the invention, each arm comprises a hook designed to cooperate with the or one of the locking reliefs to lock the accessory to the dispensing outlet.

Such an arrangement enables optimized locking of the attachment system to the dispensing outlet.

According to an advantageous feature of the invention, each hook is provided with a chamfer designed to cooperate with a front face of the or one of the locking reliefs to move the corresponding arm into an unlocked position when the accessory is attached to the dispensing outlet via a translational movement of the attachment system along the dispensing outlet.

Such an arrangement makes it easier to attach the accessory to the dispensing outlet by a simple translational movement of the attachment system and accessory along the dispensing outlet.

According to an advantageous feature of the invention, the or each locking relief defines a recess for receiving the or one of the hooks, and each hook comprises a stop surface designed, when the accessory is attached to the dispensing outlet, to cooperate with a rear face of the or one of the locking reliefs delimiting the receiving recess to keep the accessory attached to the dispensing outlet.

Such an arrangement enables optimized locking of the accessory to the dispensing outlet when the accessory is attached thereto using the attachment system.

According to an advantageous feature of the invention, the main body comprises at least one stop relief designed to limit rotation of the main body relative to the dispensing outlet.

Such an arrangement enables the accessory's rotation amplitude to be predetermined relative to the dispensing outlet offered to the user when the accessory is attached to the dispensing outlet.

According to an advantageous feature of the invention, the locked position is a rest position of the locking element to which the arms are elastically returned when no stress is exerted on the locking element.

According to an advantageous feature of the invention, the locking element has an overall hexagonal shape and the two arms extend between the bearing surface, forming an upper end of the locking element, and a connecting surface, forming a lower end of the locking element.

According to an advantageous feature of the invention, the bearing surface, the two arms and the connecting surface are made from a monoblock piece.

According to an advantageous feature of the invention, in the unlocked position the bearing surface is closer to the connecting surface than in the locked position.

According to an advantageous feature of the invention, the through port is delimited by the arms, the bearing surface and the connecting surface.

The invention also relates to an accessory for a beverage dispensing machine comprising a system for reversibly attaching the accessory to a hot water and/or steam dispensing outlet of the beverage dispensing machine, in 5 which the attachment system is as described above.

According to an advantageous feature of the invention, the accessory is chosen among: a hot water dispensing accessory or a milk frothing device such as a milk jug, or a steam nozzle or a frothing nozzle.

The invention also relates to a beverage dispensing machine comprising an outlet for dispensing hot water and/or steam and an accessory designed to be attached to the steam dispensing outlet, in which the accessory is as described above.

### BRIEF DESCRIPTION OF THE FIGURES

The purposes, aspects and advantages of the present invention, according to the description given below of a particular embodiment of the invention presented by way of non-limiting example, will be better understood by referring to the attached drawings in which:

FIG. 1 is a perspective view of a beverage dispensing machine comprising a hot water and/or steam dispensing outlet and an accessory according to a first embodiment of the invention, equipped with an attachment system according to the invention and attached to the hot water and/or steam dispensing outlet;

FIG. 2 is a perspective view of the accessory in FIG. 1 connected to the hot water and/or steam dispensing outlet;

FIG. 3 is an exploded view of the hot water and/or steam dispensing accessory and outlet in FIG. 2;

FIG. 4 is a cross-sectional view along the horizontal sectional plane along line IV-IV of the hot water and/or steam dispensing accessory and outlet in FIG. 2;

FIG. 5 is a rear cross-sectional view along the horizontal sectional plane along line V-V of the hot water and/or steam dispensing accessory and outlet in FIG. 2;

FIG. 6 is a perspective view of a locking element of the attachment system in FIG. 1;

FIG. 7 is a perspective view of an accessory according to a second embodiment of the invention, equipped with an attachment system according to the invention.

Only those elements required in order to understand the invention have been depicted. In order to facilitate interpretation of the drawings, the same elements are labeled with the same references across all the figures.

It will be noted that in this document, the terms “horizontal,” “vertical,” “lower,” “upper,” “top,” “bottom,” “front,” “rear,” “longitudinal” and “transverse” used to describe the beverage dispensing machine refer to this machine when in use, sitting flat on a countertop.

In addition, the terms “upstream” and “downstream” or “inlet” and “outlet” are defined in relation to a flow direction of the beverage or of the steam in the beverage dispensing machine.

The terms “external” and “internal” as well as the terms “outer” and “inner” are defined relative to a central axis of the beverage dispensing machine. Thus, an inner portion/part will be closer to the central axis than an outer portion/part.

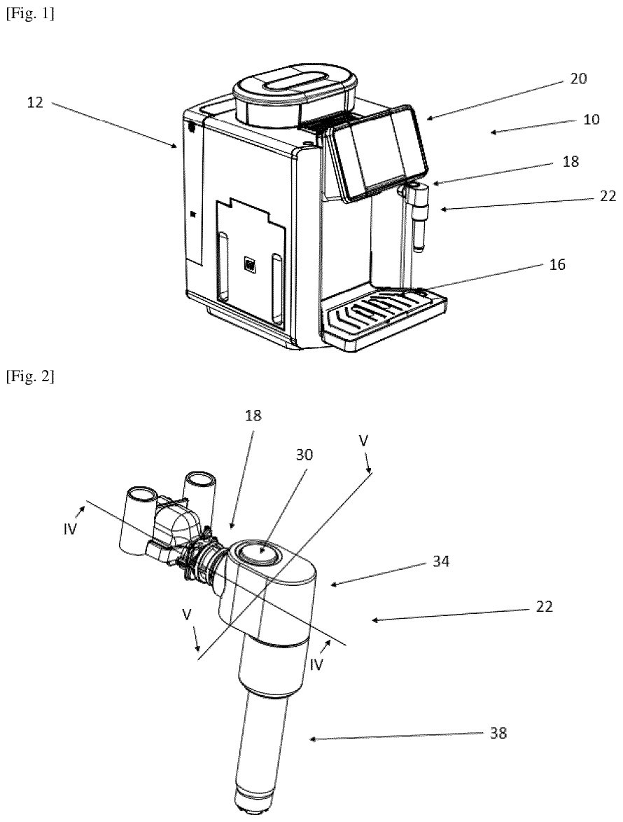

The beverage dispensing machine shown in FIG. 1 is a coffee machine 10. As a variant, the beverage dispensing machine is a hot water or tea dispensing machine.

The coffee machine 10 is advantageously an automatic coffee machine.

The coffee machine 10 comprises a frame 12 and an area 16 for receiving a container or receptacle on which a container/receptacle, not shown, can be placed.

The coffee machine 10 also comprises a beverage dispensing head, not shown, and a hot water and/or steam dispensing outlet 18.

The coffee machine 10 advantageously comprises a human-machine interface 20 by which a user can select a type of beverage to be dispensed and, advantageously, enter settings for the coffee machine 10.

The coffee machine 10 also comprises a beverage preparation unit, not shown, incorporated into the frame 12.

The preparation unit comprises a control circuit for managing the preparation of a beverage based on the instructions given by the user. The preparation unit also comprises a heating block, also referred to as a boiler, producing hot water and/or steam and a tank for holding cold water. The tank supplies the boiler to produce hot water and/or steam.

The coffee machine 10 also comprises an accessory 22, 122 reversibly attached to the hot water and/or steam dispensing outlet 18.

In FIGS. 1 to 6, the accessory 22 is designed to be immersed in a milk container to make frothed milk.

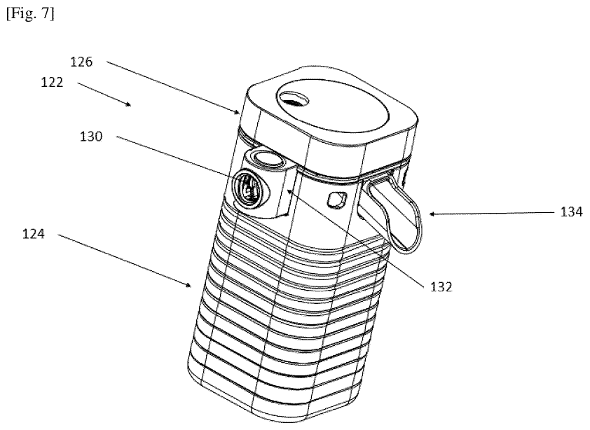

As a variant, the accessory 22, 122 is a hot water dispensing accessory or a milk frothing device such as a milk jug 122, as shown in FIG. 7, or a frothing nozzle advantageously defining a milk inlet channel, a steam inlet channel, an air inlet channel and a frothed milk outlet channel.

The hot water and/or steam dispensing outlet 18 is fluidly connected to the boiler.

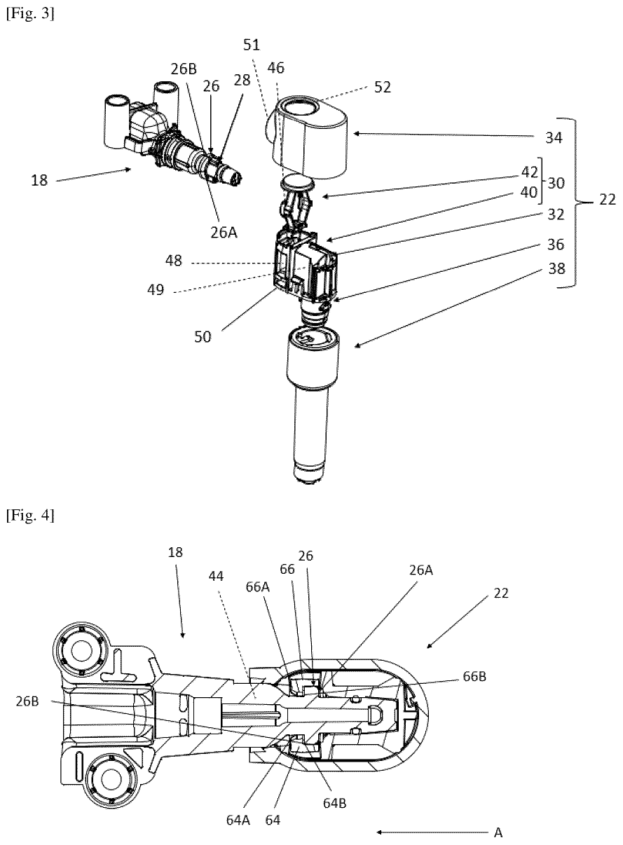

As shown in FIG. 3, the dispensing outlet 18 comprises a relief 26 for locking the accessory 22 to the dispensing outlet 18.

The locking relief 26 comprises a front face 26A and a rear face 26B.

As a variant, the dispensing outlet 18 comprises several locking reliefs.

The dispensing outlet 18 also comprises at least one blocking relief 28 designed to limit rotation of the accessory 22 relative to the dispensing outlet 18. In the example shown in FIG. 3, the dispensing outlet comprises two blocking reliefs 28.

The locking 26 and blocking reliefs 28 are formed on an outer shell of the dispensing outlet 18.

The accessory 22 comprises a system 30 for reversibly attaching the accessory 22 to the hot water and/or steam dispensing outlet 18 and a member 32 for receiving the hot water and/or steam dispensing outlet.

The accessory 22 also comprises a cover piece 34, a steam/hot water feed outlet 36 and a steam nozzle 38 designed to be immersed in a milk container.

The attachment system 30 comprises a main body 40 and a locking element 42 received in the main body 40.

The locking element 42 is designed to keep the main body 40 in place, and consequently, the accessory 22 attached to the dispensing outlet 18.

Advantageously, the main body 40 is monoblock with the receiving member 32 or forms a single piece with the receiving member 32.

Even more advantageously, the main body 40, the receiving member 42 and the steam/hot water supply outlet 36 are monoblock.

As shown in FIG. 4, the receiving member 32 comprises a port 44 for inserting the dispensing outlet 18.

The receiving member 32 also comprises, as shown in FIG. 3, a port 46 for user access to the locking element 42, through which the user can operate the locking element 42. The access port 46 is located on an upper part of the receiving member 32.

The receiving member 32 defines a recess 48 for receiving the locking element 42 and a recess 49 for receiving the dispensing outlet 18.

The receiving recess 48 is delimited by the access port 46, the insertion port 44 and a lower wall 50 supporting the locking element.

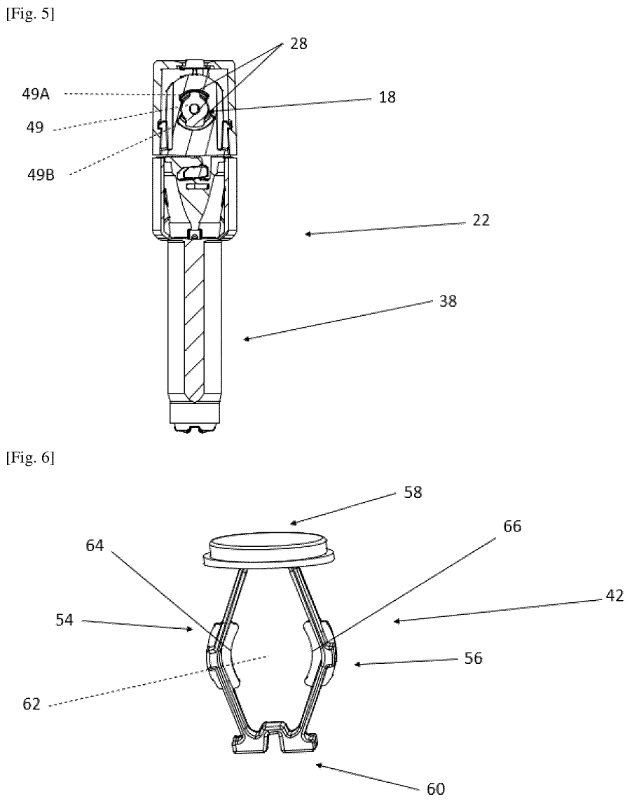

As shown in FIG. 5, the receiving recess 49 comprises at least one stop relief 49A designed to cooperate with the at least one blocking relief 28 to limit rotation of the main body 40 relative to the dispensing outlet 18. Preferably, the receiving recess comprises two stop reliefs 49A, 49B designed to cooperate with the blocking reliefs 28. The stop reliefs 49A, 49B are, for example, recesses for receiving the blocking reliefs 28 defining a left stop and a right stop for limiting the rotation of the accessory 22 around the dispensing outlet 18 in the two possible directions of rotation.

Advantageously, the receiving member 32 defines a hot water/steam flow conduit not shown in the figures.

The cover piece 34 is designed to at least partially cover the receiving member 32 and defines through ports 51, 52, shown in FIG. 3, facing the insertion port 44 and the access port 46.

The hot water/steam feed outlet 36 is fluidly connected to the hot water/steam flow conduit, which in turn is fluidly connected to the dispensing outlet 18 when the accessory 22 is attached thereto.

The steam nozzle 38 is designed to be removably attached to the hot water/steam feed outlet 36 and to receive hot water/steam from the outlet 36.

In the example shown, the main body 40 is advantageously merged with the receiving member 32 and thus comprises the insertion port 44, the access port 46, receiving recess 48 and receiving recess 49.

As shown in FIG. 6, the locking element 42 comprises two elastically deformable arms 54, 56 designed to cooperate with the locking relief 26. The arms 54, 56 are designed to be moved between a position (shown in the figures) in which the accessory 22 is locked to the dispensing outlet and an unlocked position. The locked position is advantageously the rest position to which the arms 54, 56 are elastically returned when no stress is exerted on the locking element 42.

The locking element 42 also comprises a bearing surface 58 on which the user can exert a force designed to move the arms 54, 56 from the locked position to the unlocked position.

In other words, the arms 54, 56 are designed to be moved into the unlocked position when the user presses on the bearing surface 58, and to return to the locked position when the user stops pressing.

The bearing surface 58 is accessible to the user through the access port 46.

In the example shown, the locking element 42 has an overall hexagonal shape and the two arms 54, 56 extend between the bearing surface 58, forming an upper end of the locking element 42, and a connecting surface 60, forming a lower end of the locking element 42.

Advantageously, the bearing surface 58, the two arms 54, 56 and the connecting surface 60 are made from a monoblock piece.

In the unlocked position, the bearing surface 58 is closer to the connecting surface 60 than in the locked position.

The locking element 42 comprises a through port 62 for the dispensing outlet 18 extending between the two arms 54, 56, through which the dispensing outlet 18 is arranged when the accessory 22 is attached to the dispensing outlet 18.

Advantageously, the port 62 is delimited by the arms 54, 56, the bearing surface 58 and the connecting surface 60.

The connecting surface 60 is intended to be in contact with the lower supporting wall 50.

Each arm 54, 56 comprises a hook 64, 66 designed to cooperate with the locking relief 26 to lock the accessory 22 to the dispensing outlet 18.

As shown in FIG. 4, each hook 64, 66 is provided with a chamfer 64A, 66A designed to cooperate with the front face 26A of the locking relief 26 to move the corresponding arm 54, 56 into the unlocked position when the accessory 22 is attached to the dispensing outlet 18 via a translational movement of the attachment system 30 along the dispensing outlet 18 represented by arrow A.

The locking relief 26 defines a recess for receiving the hooks, 64, 66, and each hook comprises a stop surface 64B, 66B designed, when the accessory 22 is attached to the dispensing outlet 18, to cooperate with the rear face 26B of the locking relief 26 to keep the accessory attached to the dispensing outlet. The rear face 26B delimits the receiving recess.

Advantageously, the receiving recess 49 defines an axial stop designed to come into contact with a face on the dispensing outlet 18 to define a maximum position for inserting the dispensing outlet 18 into the receiving recess 49. The maximum insertion position advantageously corresponds to an attachment position in which the stop surfaces 64B, 66B are facing the rear face 26B, preferably near the rear face 26B of the relief 26, so that the axial stop and the stop surfaces 64B, 66B, through their cooperation with the dispensing outlet 18, keep the accessory locked to the dispensing outlet 18.

The operation of the attachment system 30 will be described below through a description of the phase in which the accessory 22 is assembled to/disassembled from the dispensing outlet 18.

In a first step, the accessory 22 is provided to the user.

The user then translates the accessory and in particular the main body 40 along the dispensing outlet 18 in the direction of the arrow A, so that the dispensing outlet 18 is inserted through the insertion port 44. During this step, the chamfers 64A, 66A come into contact with the front face 26A which exerts a transverse force on the hooks 64, 66 so as to move the arms 54, 56 into the unlocked position.

Then, once the hooks 64, 66 have moved beyond the locking relief 26, the latter no longer exerts the aforementioned transverse force and the arms return to their locked position so that the stop surfaces 64B, 66B are facing the rear face 26B and the accessory is attached/locked to the dispensing outlet 18 and cannot be removed from the dispensing outlet via a translational movement in a direction opposite to that of the arrow A. Advantageously, after this step, the blocking reliefs 28 are received in the recesses formed by the stop reliefs 49A, 49B and limit the potential rotation of the accessory relative to the dispensing outlet 18.

When the user has finished using the accessory 22, it can be removed from the dispensing outlet 18 by pressing on the bearing surface 58 so as to move the arms 54, 56 from the locked position to the unlocked position in which the stop surfaces 64B, 66B are no longer facing the rear face 26B, and then by moving the accessory 22 and in particular the main body 40 along the dispensing outlet 18 in the opposite direction to that of the arrow A.

This makes it easy for the user to operate the accessory, since a simple translation enables the accessory to be attached, and a simple pressure followed by a translation enables the accessory to be separated from the dispensing outlet 18. Moreover, the strength of the attachment is optimized by the presence of the two elastically deformable hooks 64, 66. The user's safety is thus guaranteed when using and operating the accessory.

In the embodiment shown in FIG. 7, the accessory 122 is a milk jug.

To this end, the accessory 122 comprises a container 124 designed to receive milk and a frothing member 126 comprising a milk inlet channel, a steam inlet channel and a frothed milk outlet channel not clearly visible in FIG. 7.

Advantageously, the frothing member also comprises an air inlet channel.

Even more advantageously, the frothing member 126 forms an upper lid of the container 124.

The accessory 122 comprises an attachment system 130 broadly similar to the attachment system 30 in the first embodiment.

The accessory 122 also comprises a member 132 for receiving the hot water and/or steam dispensing outlet which is advantageously monoblock with the frothing member and fluidly connected to the steam inlet channel.

The accessory 122 differs from accessory 22 in that it has no steam/hot water feed outlet and no steam nozzle as described in the first embodiment in FIGS. 1 to 6.

The attachment system 130 and the receiving member 132 are positioned on a first lateral face of the accessory 122 and in particular of the container 124.

The accessory 122 also comprises an outlet 134 for dispensing frothed milk on a second lateral face of the accessory 122 and in particular of the container 124. The outlet 134 is fluidly connected to the frothed milk outlet channel.

The first lateral face and the second lateral face are oriented substantially transverse to each other.

Of course, the invention is in no way limited to the embodiment described and illustrated, which has only been provided by way of example. Changes can still be made, particularly with regard to the constitution of the various elements or by substituting technical equivalents, without departing from the scope of protection of the invention.

1. An attachment system for reversibly attaching an accessory to a hot water and/or steam dispensing outlet of a beverage dispensing machine, the attachment system comprising:
a main body; and
a locking element,
wherein the locking element is received in the main body and comprises first and second elastically deformable arms configured to cooperate with at least one locking relief formed on the dispensing outlet, the arms being configured to be moved between a position in which the accessory is locked to the dispensing outlet and an unlocked position.

2. The attachment system according to claim 1, wherein the locking element comprises a bearing surface, and wherein the first and second arms are configured to be moved into the unlocked position when a user presses on the bearing surface and to return to the locked position when the user stops pressing.

3. The attachment system according to claim 2, wherein the main body comprises an access port to the bearing surface.

4. The attachment system according to claim 1, wherein the locking element comprises a through port for the dispensing outlet extending between the first and second arms, through which the dispensing outlet is arranged when the accessory is attached to the dispensing outlet.

5. The attachment system according to claim 1, wherein the first and second arms comprises a first and second hook, respectively, configured to cooperate with one of the at least one locking reliefs to lock the accessory to the dispensing outlet.

6. The attachment system according to claim 5, wherein each hook is provided with a chamfer configured to cooperate with a front face of one of the at least one locking reliefs to move the corresponding one of the first and second arms into an unlocked position when the accessory is attached to the dispensing outlet via a translational movement of the attachment system along the dispensing outlet.

7. The attachment system according to claim 5, wherein the at least one locking relief defines a recess for receiving one of the first and second hooks, and wherein each of the first and second hooks comprises a stop surface configured, when the accessory is attached to the dispensing outlet, to cooperate with a rear face of one of the at least one locking reliefs delimiting the receiving recess to keep the accessory attached to the dispensing outlet.

8. The attachment system according to claim 1, wherein the main body comprises at least one stop relief designed configured to limit the rotation of the main body relative to the dispensing outlet.

9. An accessory for a beverage dispensing machine comprising an attachment system for reversibly attaching the accessory to a hot water and/or steam dispensing outlet of the beverage dispensing machine, wherein the attachment system is comprises the attachment system according to claim 1.

10. A beverage dispensing machine comprising an outlet for dispensing hot water and/or steam and an accessory configured to be attached to the dispensing outlet, wherein the accessory comprises the accessory according to claim 9.
